(19) United States
(12) Patent Application Publication
(10) Pub. No.: US 2004/0075722 A1
(43) Pub. Date: Apr. 22, 2004

(54) Ink-jet printhead and method for manufacturing the same

(76) Inventors: Chang-Seung Lee, Seongnam-city (KR); Keon Kuk, Yongin-city (KR); Seung-Ju Shin, Seongnam-city (KR); Yong-Soo Oh, Seongnam-city (KR); Jun-Hyub Park, Seongnam-city (KR); Hyung-Taek Lim, Seoul (KR)

Correspondence Address: LEE & STERBA, P.C., 1101 Wilson Boulevard, Suite 2000, Arlington, VA, 22209, US

(21) Appl. No.: 10/682,961

(22) Filed: Oct. 14, 2003

(30) Foreign Application Priority Data
Oct. 15, 2002 (KR) 2002-62702

(51) Int. Cl. B41J 2/175

(52) U.S. Cl. 347/93

(57) ABSTRACT

An ink-jet printhead includes a substrate having an ink chamber on a front surface thereof, the ink chamber to be supplied with ink to be ejected, a manifold for supplying ink to the ink chamber on a rear surface thereof, and an ink channel in communication with the ink chamber and the manifold, an impurity filtering layer formed on the rear surface of the substrate between the manifold and the ink channel for filtering impurities in ink flowing into the ink channel from the manifold, a nozzle plate formed on the front surface of the substrate, a nozzle formed through the nozzle plate at a position corresponding to a central part of the ink chamber, a heater formed on the nozzle plate, the heater being formed around the nozzle, and an electrode electrically connected to the heater for applying current to the heater.

### BACKGROUND OF THE INVENTION

1. Field of the Invention

The present invention relates to an ink-jet printhead having an improved structure that is capable of filtering impurity particles and a method for manufacturing the same.

2. Description of the Related Art

In general, ink-jet printheads are devices for printing a predetermined image, color or black, by ejecting a small volume droplet of a printing ink at a desired position on a recording sheet. Ink-jet printheads are largely categorized into two types depending on the ink droplet ejection mechanisms: an electro-thermal transducer type (bubble-jet type), in which a heat source is employed to form a bubble in ink, thereby causing the ink to be ejected, and an electromechanical transducer type in which ink is ejected by a change in ink volume due to deformation of a piezoelectric element.

Hereinafter, the ink ejection mechanism in a thermal ink-jet printhead will be described in greater detail. When current having a pulse shape flows through a heater formed of a resistance heating material, heat is generated in the heater. The heat causes ink adjacent to the heater to be instantaneously heated to about 300° C., thereby boiling the ink and generating a bubble in the ink. The bubble expands and applies pressure to an inside of an ink chamber filled with ink. As a result, ink in the vicinity of a nozzle is ejected in a droplet shape through the nozzle from the ink chamber.

A thermal driving method may be further divided into a top-shooting method, a side-shooting method, and a back-shooting method according to a growth direction of bubbles and an ejection direction of ink droplets.

The top-shooting method is a method in which the growth direction of a bubble is the same as the ejection direction of an ink droplet. The side-shooting method is a method in which the growth direction of a bubble is perpendicular to the ejection direction of an ink droplet. The back-shooting method is a method in which the growth direction of a bubble is opposite to the ejection direction of an ink droplet.

An ink-jet printhead using the thermal driving method should satisfy the following requirements. First, manufacturing of the ink-jet printheads has to be simple, costs have to be low, and mass production thereof has to be possible. Second, in order to obtain a high-quality image, cross-talk between adjacent nozzles has to be suppressed and an interval therebetween has to be narrow. Third, in order to perform a high-speed printing operation, a period in which the ink chamber is refilled with ink after being ejected from the ink chamber has to be as short as possible. That is, the heated ink and heater should cool down quickly to increase an operating frequency.

In operation, impurity particles in ink lower the performance of an ink-jet printhead. More specifically, when an ink channel is clogged with impurity particles, ink is not supplied to an ink chamber, thus ink is not ejected through nozzles and a heater may be damaged. The impurity particles may flow into ink even when a head chip and a cartridge are assembled. In addition, fine impurity particles may still be present in ink even though ink passes through a filter for the cartridge. Thus, in order to improve the performance of an ink-jet printhead by filtering impurities in ink, impurity particles should be prevented from clogging an ink passage or flowing to the ink chamber.

FIG. 1 illustrates a plan view of a conventional ink-jet printhead in which impurity particles are filtered. Referring to FIG. 1, ink is supplied to heaters 401 and 403 through ink channels 409, 411, 413, and 415 from a manifold 407. In this arrangement, the ink-jet printhead prevents impurity particles 433 and 435 from flowing to the heaters 401 and 403, using island structures 417, 419, 423, 425, 427, 429, and 431 using a photoresist on an ink passage.

FIG. 2 illustrates a perspective view of another conventional ink-jet printhead. Referring to FIG. 2, the ink-jet printhead uses a plurality of slits 64 formed on a nozzle plate 48 as an ink passage for supplying ink to an ink chamber 74 such that impurity particles are prevented from flowing into the ink chamber 74. In FIG. 2, reference numerals 72 and 84 indicate a heater and a nozzle, respectively.

The two above-described conventional ink-jet printheads, however, have a limitation of filtering fine impurity particles. In addition, the above structures can be applied only when an ink channel is formed parallel to a surface of a substrate. However, when the ink channel is formed perpendicular to the surface of the substrate, it is not easy to apply the above structures. That is, it is not easy to form an island structure on a cylindrical ink channel formed perpendicular to the surface of the substrate. Further, even though the island structure is formed on the ink channel, ink is not smoothly supplied to an ink chamber.

### SUMMARY OF THE INVENTION

It is a first feature of an embodiment of the present invention to provide an ink-jet printhead in which fine impurity particles are filtered through an impurity filtering layer formed between a manifold and an ink channel such that the performance of the printhead is improved, and a method for manufacturing the same.

According to a feature of an embodiment of the present invention, there is provided an ink-jet printhead including a substrate having an ink chamber on a front surface thereof, the ink chamber to be supplied with ink to be ejected, a manifold for supplying ink to the ink chamber on a rear surface thereof, and an ink channel in communication with the ink chamber and the manifold, an impurity filtering layer formed on the rear surface of the substrate between the manifold and the ink channel for filtering impurities in ink flowing into the ink channel from the manifold, a nozzle plate formed on the front surface of the substrate, a nozzle formed through the nozzle plate at a position corresponding to a central part of the ink chamber, a heater formed on the nozzle plate, the heater being formed around the nozzle, and an electrode electrically connected to the heater for applying current to the heater.

The ink-jet printhead may additionally include a heater passivation layer formed on the heater and the nozzle plate, and an electrode passivation layer formed on the electrode and the heater passivation layer.

Preferably, the impurity filtering layer is a thin layer having a mesh portion formed therein at a location corresponding to the ink channel. Preferably, the impurity filtering layer is formed of silicon oxide or silicon nitride and has a thickness of less than about 1 μm.

Preferably, the ink chamber has a substantially hemispherical shape. Preferably, the ink channel is formed perpendicular to the front surface of the substrate.

The nozzle plate may further include a nozzle guide that extends in a depth direction of the ink chamber from an edge of the nozzle.

According to another feature of an embodiment of the present invention, there is provided a method for manufacturing an ink-jet printhead including depositing a nozzle plate, in which a heater and an electrode electrically connected to the heater are arranged, on a front surface of a substrate, and forming a nozzle through the nozzle plate to expose a portion of the substrate, forming a manifold by etching a rear surface of the substrate, forming an impurity filtering layer on the rear surface of the substrate, forming an ink chamber by etching the substrate exposed by the nozzle, and forming an ink channel for providing communication between the ink chamber and the manifold by etching the substrate from a bottom surface of the ink chamber.

Preferably, forming the impurity filtering layer includes depositing a thin layer on the rear surface of the substrate, and forming a mesh portion in the thin layer by patterning the thin layer. Preferably, the thin layer is a silicon oxide layer or silicon nitride layer formed to a thickness of less than about 1 μm by plasma enhanced chemical vapor deposition (PE CVD) or sputtering and the thin layer is patterned by reaction ion etching (RIE) to form the impurity filtering layer.

Preferably, forming the ink chamber includes forming the ink chamber having a substantially hemispherical shape by isotropically etching the substrate exposed by the nozzle.

Forming the ink chamber may further include forming a trench by anisotropically etching the substrate exposed by the nozzle to a predetermined depth, depositing a predetermined material layer on an entire surface of the substrate having been anisotropically etched, exposing a bottom of the trench by isotropically etching the material layer and simultaneously forming a nozzle guide from the material layer on a sidewall of the trench, and forming the ink chamber having a substantially hemispherical shape by isotropically etching the substrate exposed by the nozzle.

Further, forming the ink channel may be providing communication between the ink chamber and the manifold by etching the substrate perpendicular to the front surface of the substrate from the bottom surface of the ink chamber.

As described above, the present invention provides an ink-jet printhead having an improved structure in which impurities in ink are filtered such that the performance of the printhead is improved, and a method for manufacturing the same.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIG. 1 illustrates a plan view of a conventional ink-jet printhead;

FIG. 2 illustrates a perspective view of another conventional ink-jet printhead;

FIG. 3 illustrates a plan view schematically showing a structure of an ink-jet printhead according to an embodiment of the present invention;

FIG. 4 illustrates a plan view of an enlarged portion A of FIG. 3;

FIG. 5 illustrates a cross-sectional view of the vertical structure of the ink-jet printhead taken along line 1-1;

FIG. 6 illustrates a plan view of an enlarged mesh portion of an impurity filtering layer shown in FIG. 4;

FIG. 7 illustrates a cross-sectional view of an ink-jet printhead according to an embodiment of the present invention;

FIGS. 8 through 14 illustrate cross-sectional views showing stages in a method for manufacturing an ink-jet printhead shown in FIG. 5; and

FIGS. 15 through 19 illustrate cross-sectional views showing stages in a method for manufacturing the ink-jet printhead shown in FIG. 7.

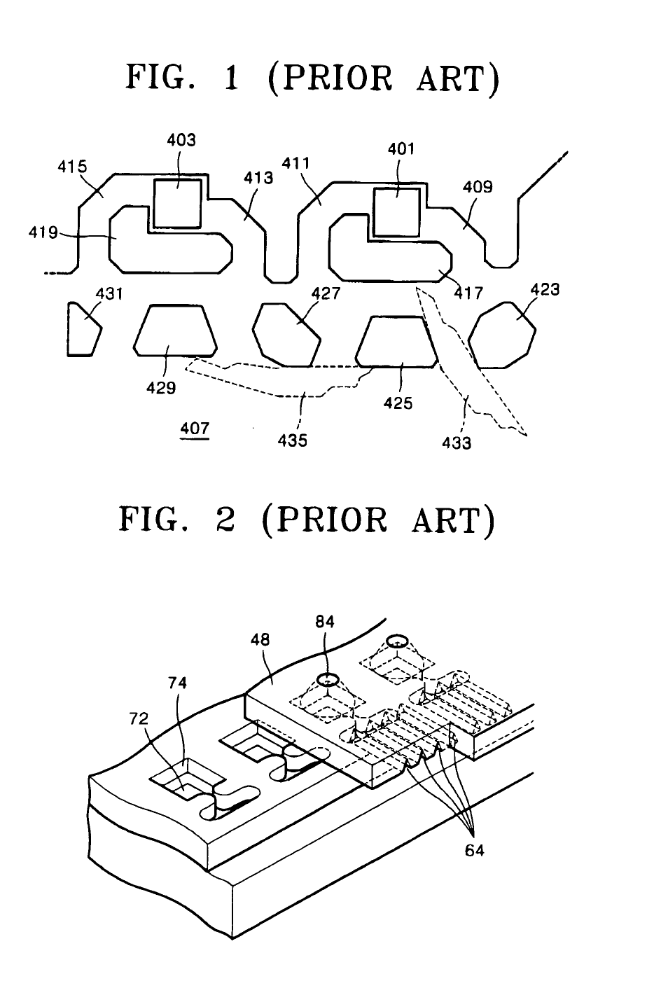

### DETAILED DESCRIPTION OF THE INVENTION

Korean Patent Application No. 2002-62702, filed on Oct. 15, 2002, and entitled: “Ink-Jet Printhead and Method for Manufacturing the Same,” is incorporated by reference herein in its entirety.

The present invention will now be described more fully hereinafter with reference to the accompanying drawings, in which a preferred embodiment of the invention is shown. The invention may, however, be embodied in different forms and should not be construed as limited to the embodiment set forth herein. Rather, this embodiment is provided so that this disclosure will be thorough and complete, and will fully convey the scope of the invention to those skilled in the art. In the drawings, the thickness of layers and regions and the sizes of components may be exaggerated for clarity. It will also be understood that when a layer is referred to as being “on” another layer or substrate, it can be directly on the other layer or substrate, or intervening layers may also be present. Like reference numerals refer to like elements throughout.

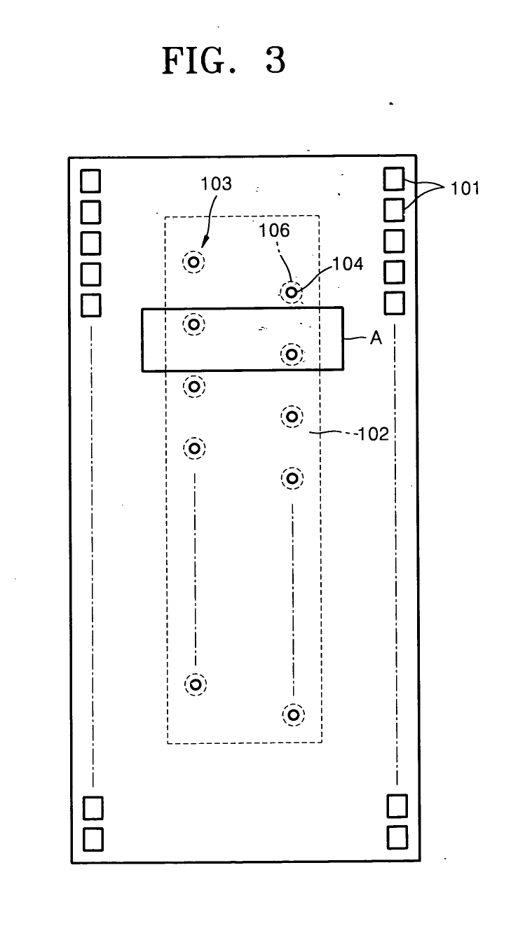

FIG. 3 illustrates a plan view schematically showing a structure of an ink-jet printhead according to an embodiment of the present invention. Referring to FIG. 3, the ink-jet printhead includes ink ejecting portions 103 arranged in two rows on a manifold 102 (indicated by a dotted line) for supplying ink and bonding pads 101, each of the bonding pads being electrically connected to a corresponding one of the ink ejecting portions 103. The manifold 102 is connected to an ink container (not shown) in which ink is stored. In the drawing, the ink ejecting portions 103 are arranged in two rows, however, the ink ejecting portions 103 may be arranged in one row or in three or more rows in order to improve printing resolution. In addition, a separate manifold 102 may be formed in communication with each row of each ink ejecting portions 103. Each of the ink ejecting portions 103 includes a nozzle 104 and an ink chamber 106.

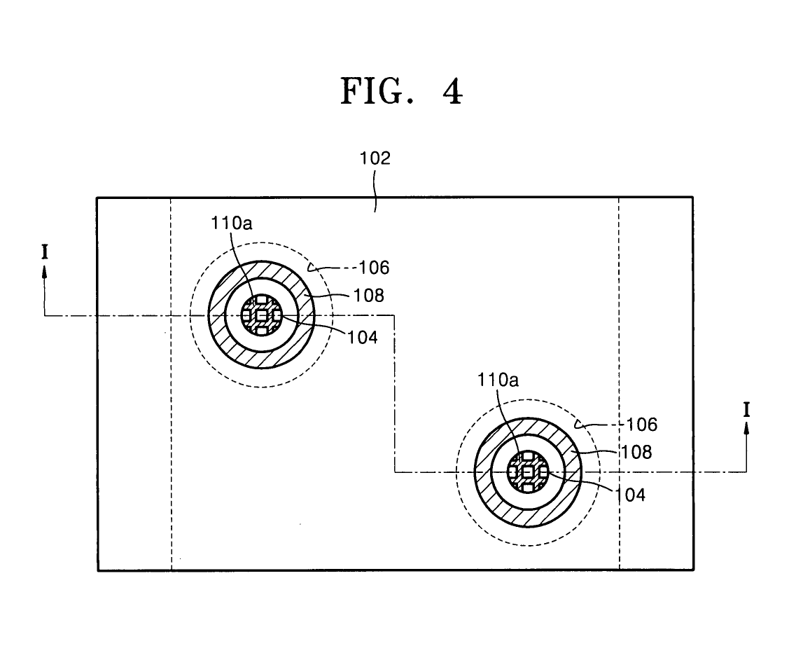

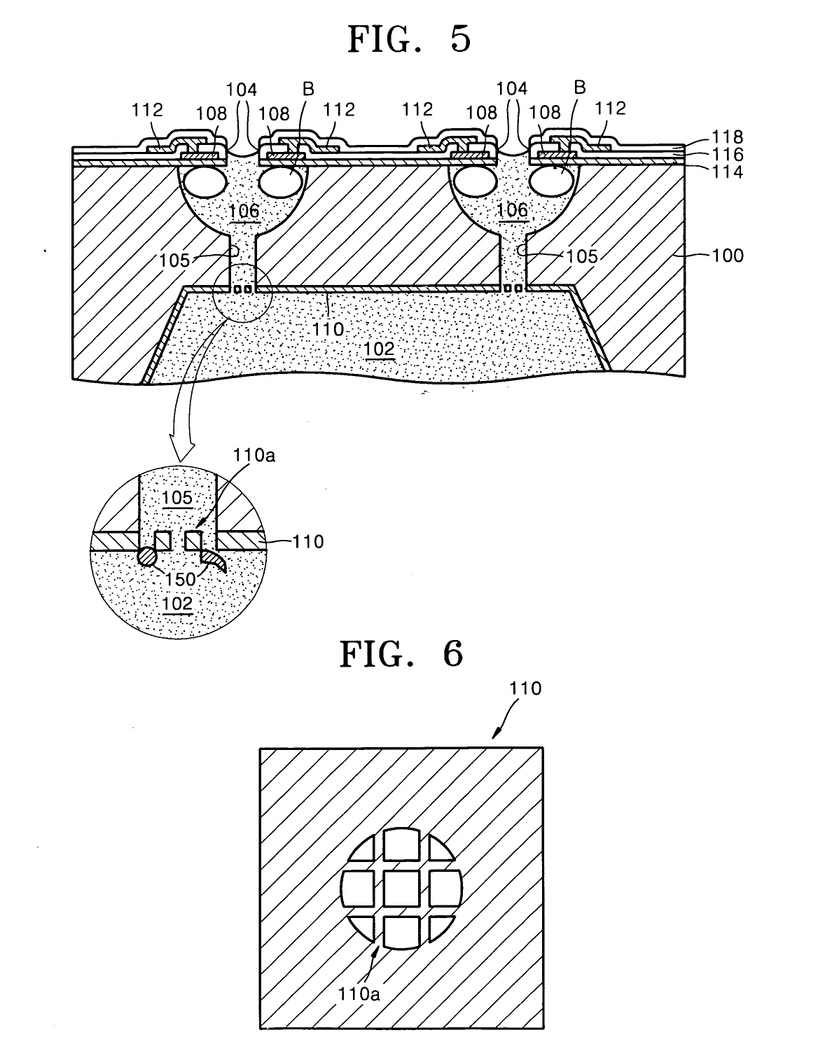

FIG. 4 illustrates a plan view of an enlarged portion A of FIG. 3. FIG. 5 illustrates a cross-sectional view of the vertical structure of the ink-jet printhead taken along line I-I of FIG. 4. Referring to FIGS. 4 and 5, the structure of the ink-jet printhead according to the present embodiment of the present invention will be described below.

First, an ink chamber 106 is formed in having a substantially hemispherical shape on a front surface of a substrate 100. A manifold 102 for supplying ink to an ink chamber 106 is formed on a rear surface of the substrate 100. Here, the substrate 100 is generally formed of silicon, which is widely used to manufacture an integrated circuit.

An ink channel 105 for providing communication between the ink chamber 106 and the manifold 102 is formed in a cylindrical shape perpendicular to the front surface of the substrate 100 between the ink chamber 106 and the manifold 102.

A nozzle plate 114 is stacked on the surface of the substrate 100 and forms an upper wall of the ink chamber 106. Nozzles 104 are formed through the nozzle plate 114 at a position corresponding to a central part of the ink chamber 106. When the substrate 100 is formed of silicon, the nozzle plate 114 may be a silicon oxide layer formed by oxidizing silicon or a silicon nitride layer deposited on the substrate 100.

A heater 108 for generating bubbles around the nozzles 104 is formed on the nozzle plate 114. The heater 108 is formed of a resistance heating material such as impurity-doped polycrystalline silicon, tantalum-aluminum alloy, titanium nitride (TiN), or tantalum nitride (TaN). An electrode 112 for applying a pulse current is connected to the heater 108. The electrode 112 is formed of the same material as used to form the bonding pads (101 of FIG. 3) and a wire line (not shown). For example, this material may be a metal such as aluminum or aluminum alloy. In addition, a heater passivation layer 116 and an electrode passivation layer 108 are formed on the heater 108 and the electrode 112, respectively, so as to passivate the heater 108 and the electrode 112.

An impurity filtering layer 110 is formed on the rear surface of the substrate between the manifold 102 and the ink channel 105 to prevent impurity particles 150 in ink from flowing into the ink chamber 106 from the manifold 102. The impurity filtering layer 110 is a thin layer stacked on the rear surface of the substrate 100. As shown in FIG. 6, a mesh portion 110a is formed in a portion of the impurity filtering layer 110, which is connected to the ink channel 105 from the manifold 102. Thus, small impurity particles 150 can be also filtered through the mesh portion 110a. The impurity filtering layer 110 is formed of a silicon oxide layer or a silicon nitride layer having the thickness less than about 1 μm. The mesh portion 110a is formed by patterning a thin layer stacked on the rear surface of the substrate 100. Accordingly, the mesh portion 110a can easily change flow resistance by adjusting a size of the mesh thereof.

In the above structure, ink in the manifold 102 is filtered while passing through the mesh portion 110a of the impurity filtering layer 110. Subsequently, filtered ink is supplied to the ink chamber 106 through the ink channel 105.

In operation, when a pulse current is applied to the heater 108 when ink fills the ink chamber 106, heat generated in the heater 108 is transferred through the nozzle plate 114 below the heater 108. As a result, ink below the heater 108 is boiled, and bubbles (B) are generated in ink.

As time passes, the bubbles (B) expand. Then, due to pressure generated by the bubbles B, ink in the ink chamber 106 is ejected through the nozzles 104.

Next, when the current is cut off, the bubbles (B) collapse, and filtered ink refills the ink chamber 106.

As described above, ink in the manifold 102 is filtered while passing through the mesh portion 110a of the impurity filtering layer 110 and fills the ink chamber 106. Thus, the impurity particles 150 in ink are prevented from being stuck in the ink channel 105 or flowing into the ink chamber 106.

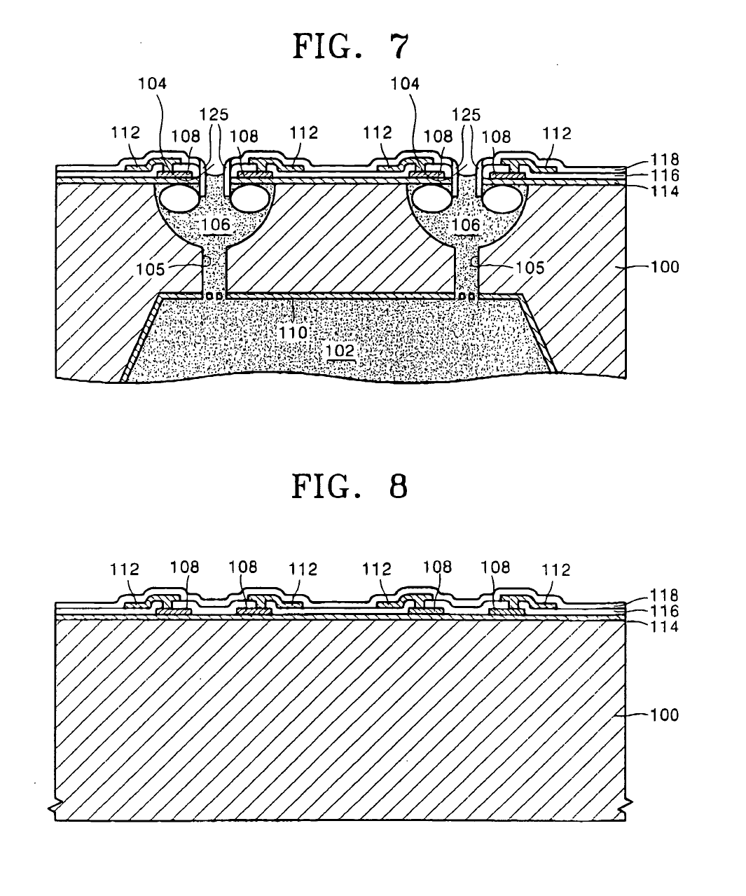

FIG. 7 illustrates a cross-sectional view illustrating an ink-jet printehad according to an embodiment of the present invention. The present embodiment of FIG. 7 is different from the above-described embodiment of the ink-jet printhead in that a nozzle guide 125 extends in the ink chamber 106 from an edge of the nozzle 104. The nozzle guide 125 guides an ejection direction of ink droplets when the bubbles (B) grow such that the droplets are ejected through the nozzles 104 in a direction precisely perpendicular to the surface of the substrate 100.

A method for manufacturing an ink-jet printhead according to an embodiment of the present invention will now be described. FIGS. 8 through 14 illustrate cross-sectional views showing stages in a method for manufacturing the ink-jet printhead as shown in FIG. 5.

FIG. 8 illustrates a stage where the nozzle plate 114 is formed on the surface of the substrate 100 and the heater 108 and the electrode 112 are formed on the nozzle plate 114. Then, the heater passivation layer 116 and the electrode passivation layer 118 are sequentially formed on the nozzle plate 114 and the heater 108, and the electrode 112 and the heater passivation layer 116, respectively.

In general, a silicon substrate is typically used as the substrate 100, because a silicon wafer that is widely used to manufacture semiconductor devices can be used without change, and thus is effective in mass production. If the silicon substrate 100 is put in an oxidation furnace and wet or dry oxidized, a silicon oxide layer, which will be the nozzle plate 114, is formed on the surface of the silicon substrate 100. The nozzles 104 are formed later in the nozzle plate 114.

After forming the nozzle plate 114 on the front surface of the substrate, the heater 108 is formed on the nozzle plate 114. The heater 108 is formed by depositing impurity-doped polycrystalline silicon or tantalum-aluminum alloy on the entire surface of the nozzle plate 114, which is a silicon oxide layer, and patterning a deposited resultant. Specifically, impurity-doped polycrystalline silicon may be formed to a thickness of between about 0.5-2 μm by depositing polycrystalline silicon together with impurities by low-pressure chemical vapor deposition (LPCVD). When the heater 108 is formed of tantalum-aluminum alloy, a tantalum-aluminum alloy layer may be formed to a thickness of between about 0.1-0.3 μm by depositing tantalum-aluminum alloy by sputtering. The deposition thickness of the polycrystalline silicon layer or tantalum-aluminum alloy layer may be different to provide proper resistance in consideration of the width and length of the heater 108. Subsequently, the polycrystalline silicon layer or the tantalum-aluminum alloy layer deposited on the nozzle plate 114 is patterned by an etch process.

Next, the heater passivation layer 116, which is a silicon nitride layer, is deposited on the entire surface of the nozzle plate 114 on which the heater 108 is formed, to a thickness of about 0.5 μm by LPCVD. The heater passivation layer 116 deposited on the heater 108 is etched such that a portion of the heater 108 to be connected to the electrode 112 is exposed. Subsequently, metal of good conductivity that can be easily patterned, for example, aluminum or aluminum alloy, is deposited to a thickness of about 1 μm by sputtering and then patterned, thereby forming the electrode 112. In this case, a metallic layer for the electrode 112 is patterned so that a wire line (not shown) and bonding pads (101 of FIG. 3) are simultaneously formed in different portions of the substrate 100. Subsequently, the electrode passivation layer 118, which is a tetraethylorthosilane (TEOS) oxide layer, is deposited on the entire surface of the nozzle plate 114 in which the electrode 112 is formed. The TEOS oxide layer is deposited to a thickness of about 1 μm at a temperature below about 400° C. by CVD so that the electrode 112 and the bonding pads (101 of FIG. 3) are not damaged.

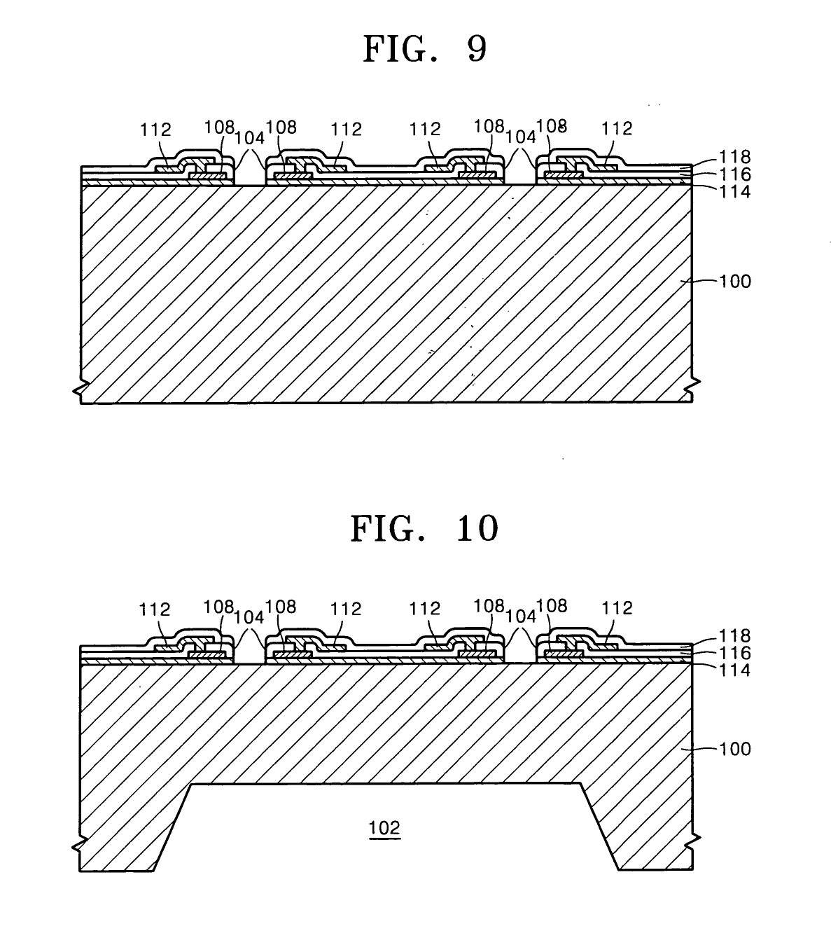

FIG. 9 illustrates a stage where the nozzles 104 are formed in the nozzle plate 114. Specifically, the electrode passivation layer 118, the heater passivation layer 116, and the nozzle plate 114 are sequentially etched to a size smaller than an inner dimension of the heater 108, thereby exposing a portion the substrate 100 where the nozzles 104 are to be formed.

FIG. 10 illustrates a stage where the manifold 102 is formed on a rear surface of the substrate 100. Specifically, a silicon oxide layer is deposited to a thickness of about 1 μm on the rear surface of the silicon substrate 100 and patterned, thereby forming an etch mask that defines a region to be etched. Next, the substrate 100 exposed to the etch mask is wet etched to a depth of about 300-400 μm using tetramethyl ammonium hydroxide (TMAH) as an etchant, or is dry etched by inductively coupled plasma-reactive ion etching (ICP-RIE), thereby forming the manifold 102 on the rear surface of the substrate 100. Alternately, the manifold 102 may be formed by etching the rear surface of the substrate 100 before the nozzles 104 are formed. In addition, the manifold 102 is formed by anisotropically wet etching the rear surface of the substrate 100, but may be formed by anisotropically dry etching the rear surface of the substrate 100.

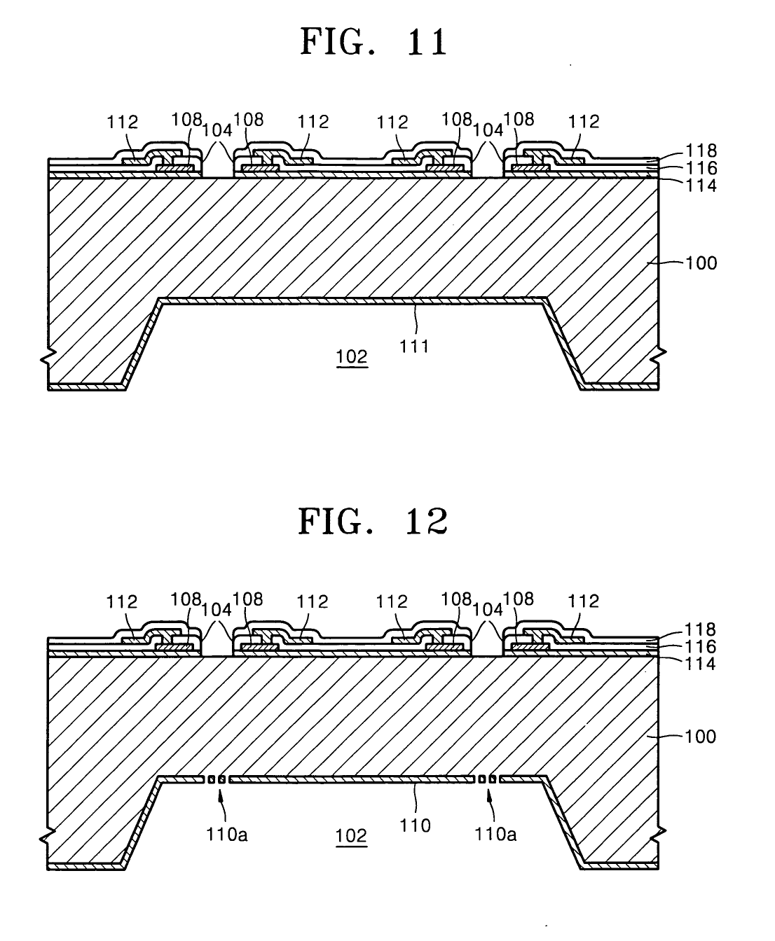

FIGS. 11 and 12 illustrate the stage in which the impurity filtering layer 110 is formed on the rear surface of the substrate 100. First, as shown in FIG. 11, a thin layer 111 is deposited to a thickness of less than about 1 μm on the rear surface of the substrate 100, by plasma enhanced chemical vapor deposition (PE CVD) or sputtering. In this case, the thin layer 111 may be a silicon oxide layer or a silicon nitride layer. Next, as shown in FIG. 12, the thin layer 111 is patterned by reaction ion etching (RIE), thereby forming the impurity filtering layer 110. The mesh portion 110a, through which impurity particles are filtered, is formed in the impurity filtering layer 110 at a location corresponding to the ink channel 105, which will be formed later.

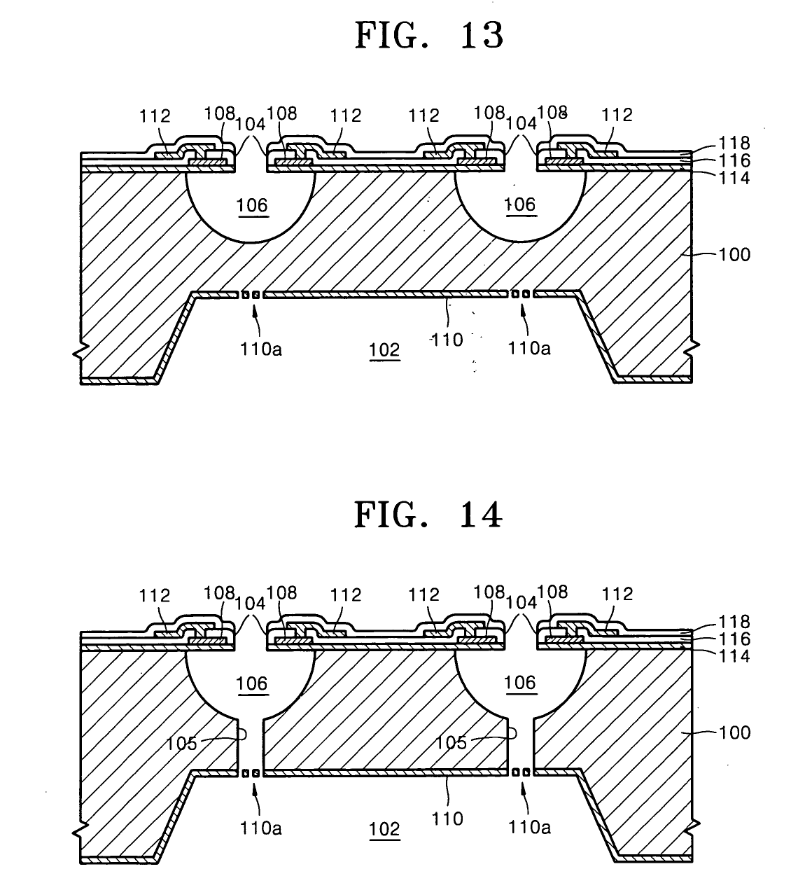

FIG. 13 illustrates a stage where the ink chamber 106 is formed on the front surface of the substrate 100. Specifically, the ink chamber 106 is formed by isotropically etching the substrate 100 exposed by the nozzles 104 using an etch gas, such as an XeF₂ gas. Preferably, the shape of the ink chamber 106 is a substantially hemispherical shape.

FIG. 14 illustrates a stage where the ink channel 105 is formed. Specifically, the substrate 100 which forms a bottom surface of the ink chamber 106, is anisotropically etched perpendicular to the surface of the substrate 100 by ICP-RIE, thereby forming the ink channel 105 for providing communication between the manifold 102 and the ink chamber 106.

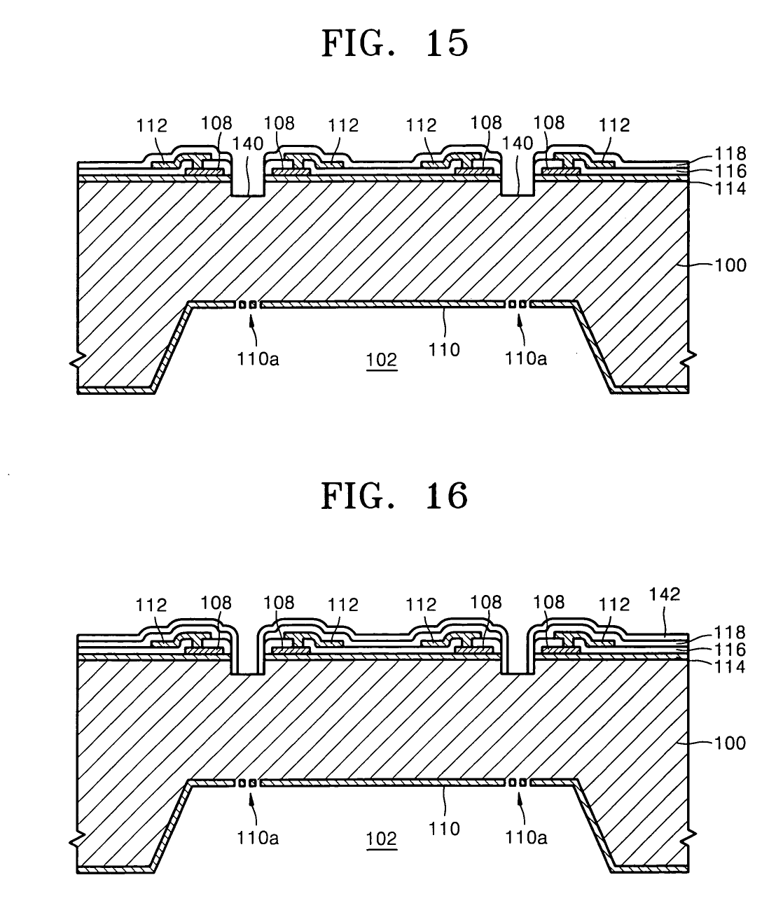

FIGS. 15 through 19 illustrate cross-sectional views showing a method for manufacturing the ink-jet printhead shown in FIG. 7. The method is the same as the above-described method for manufacturing an ink-jet printhead, except for an additional step of forming the nozzle guide 125. Accordingly, only the formation of the nozzle guide 125 will be described below.

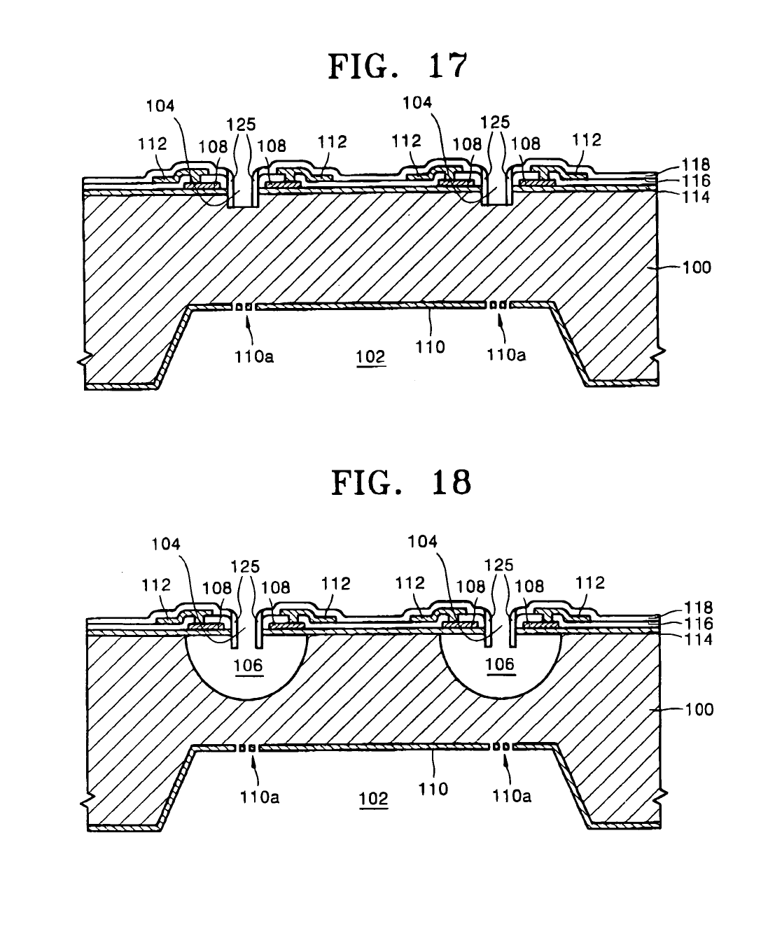

The substrate 100 exposed by the nozzles 104 are anisotropically etched in a state shown in FIG. 12, thereby forming a trench 140 having a predetermined depth, as shown in FIG. 15. Subsequently, a predetermined material layer 142 such as a TEOS oxide layer, is deposited on the entire surface of the trench 140, as shown in FIG. 16. Next, the material layer 142 is anisotropically etched until the substrate 100 is exposed. As a result, the nozzle guide 125 is formed on sidewalls of the trench 140, as shown in FIG. 17.

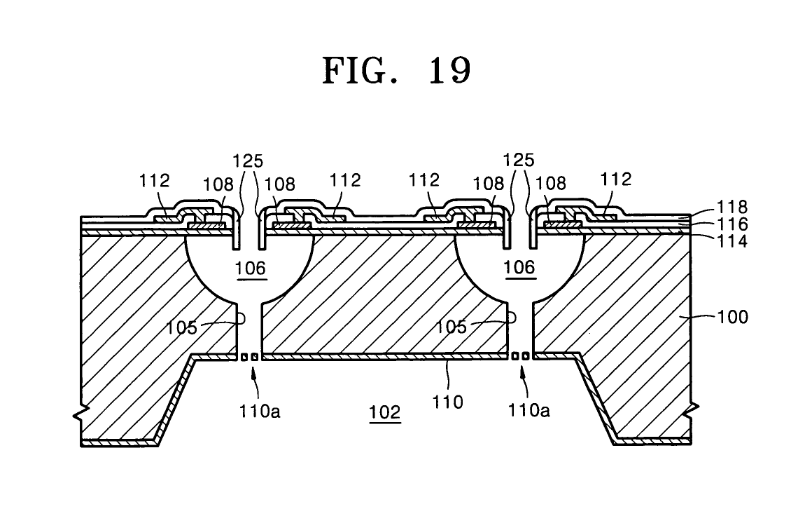

Next, as described above, the substrate 100 exposed by the nozzles 104 is isotropically etched in a state shown in FIG. 17, thereby forming the ink chamber 106 having a substantially hemispherical shape, as shown in FIG. 18. Subsequently, the substrate 100 which forms a bottom surface of the ink chamber 106, is anisotropically etched, thereby forming the ink channel 105 for providing communication between the manifold 102 and the ink chamber 106, as shown in FIG. 19.

As described above, in the ink-jet printhead according to the present invention, fine impurity particles are filtered through an impurity filtering layer having a mesh portion formed between a manifold and an ink channel, such that impurity particles in ink are prevented from clogging an ink channel or flowing into an ink chamber. Accordingly, a cause of ejection defects or heater damage, which may occur when ink is not supplied to the ink chamber, is preempted, thereby improving the performance of the printhead.

In addition, in the ink-jet printhead according to the present invention, flow resistance can be easily changed by adjusting a size of the mesh of the mesh portion formed in the impurity filtering layer.

Although preferred embodiments of the present invention are described in detail as above, the scope of the present invention is not limited to these embodiments but various changes and other embodiments may be made. Accordingly, only an exemplary material used in forming each element of an ink-jet printhead according to the present invention has been just explained, and a variety of materials may be used to form elements. In addition, only an exemplary method for depositing and forming each material has been just explained, and a variety of deposition and etch methods may be applied to an ink-jet printhead according to the present invention. Moreover, the order of each step of the method for manufacturing the ink-jet printhead may be varied, and specific values exemplified in each step may be adjusted within a range where the ink-jet printhead can operate normally. Thus, while the present invention has been particularly shown and described with reference to a preferred embodiment thereof, it will be understood by those skilled in the art that various changes in form and details may be made therein without departing from the spirit and scope of the invention as defined by the appended claims.

What is claimed is:

1. An ink-jet printhead, comprising:
a substrate having an ink chamber on a front surface thereof, the ink chamber to be supplied with ink to be ejected, a manifold for supplying ink to the ink chamber on a rear surface thereof, and an ink channel in communication with the ink chamber and the manifold;
an impurity filtering layer formed on the rear surface of the substrate between the manifold and the ink channel for filtering impurities in ink flowing into the ink channel from the manifold;
a nozzle plate formed on the front surface of the substrate;
a nozzle formed through the nozzle plate at a position corresponding to a central part of the ink chamber;
a heater formed on the nozzle plate, the heater being formed around the nozzle; and
an electrode electrically connected to the heater for applying current to the heater.

2. The printhead as claimed in claim 1, further comprising:
a heater passivation layer formed on the heater and the nozzle plate; and
an electrode passivation layer formed on the electrode and the heater passivation layer.

3. The printhead as claimed in claim 1, wherein the impurity filtering layer is a thin layer having a mesh portion formed therein at a location corresponding to the ink channel.

4. The printhead as claimed in claim 1, wherein the impurity filtering layer is formed of silicon oxide or silicon nitride.

5. The printhead as claimed in claim 1, wherein the impurity filtering layer has a thickness of less than about 1 μm.

6. The printhead as claimed in claim 1, wherein the ink chamber has a substantially hemispherical shape.

7. The printhead as claimed in claim 1, wherein the ink channel is formed perpendicular to the front surface of the substrate.

8. The printhead as claimed in claim 1, wherein the nozzle plate further comprises:
a nozzle guide that extends in a depth direction of the ink chamber from an edge of the nozzle.

9. A method for manufacturing an ink-jet printhead, comprising:
depositing a nozzle plate, in which a heater and an electrode electrically connected to the heater are arranged, on a front surface of a substrate, and forming a nozzle through the nozzle plate to expose a portion of the substrate;
forming a manifold by etching a rear surface of the substrate;
forming an impurity filtering layer on the rear surface of the substrate;
forming an ink chamber by etching the substrate exposed by the nozzle; and
forming an ink channel for providing communication between the ink chamber and the manifold by etching the substrate from a bottom surface of the ink chamber.

10. The method as claimed in claim 9, wherein forming the impurity filtering layer comprises:
depositing a thin layer on the rear surface of the substrate; and
forming a mesh portion in the thin layer by patterning the thin layer.

11. The method as claimed in claim 10, wherein the thin layer is a silicon oxide layer or silicon nitride layer formed to a thickness of less than about 1 μm.

12. The method as claimed in claim 10, wherein the thin layer is formed by plasma enhanced chemical vapor deposition (PE CVD) or sputtering.

13. The method as claimed in claim 10, wherein the thin layer is patterned by reaction ion etching (RIE) to form the impurity filtering layer.

14. The method as claimed in claim 9, wherein forming the ink chamber comprises:
forming the ink chamber having a substantially hemispherical shape by isotropically etching the substrate exposed by the nozzle.

15. The method as claimed in claim 9, wherein forming the ink chamber further comprises:
forming a trench by anisotropically etching the substrate exposed by the nozzle to a predetermined depth;
depositing a predetermined material layer on an entire surface of the substrate having been anisotropically etched;
exposing a bottom of the trench by isotropically etching the material layer and simultaneously forming a nozzle guide from the material layer on a sidewall of the trench; and
forming the ink chamber having a substantially hemispherical shape by isotropically etching the substrate exposed by the nozzle.

16. The method as claimed in claim 9, wherein forming the ink channel is providing communication between the ink chamber and the manifold by etching the substrate perpendicular to the front surface of the substrate from the bottom surface of the ink chamber.
